(19) United States
(12) Patent Application Publication
(10) Pub. No.: US 2003/0054701 A1
(43) Pub. Date: Mar. 20, 2003

(54) Electrical connector

(76) Inventors: Rick Neil Hutchinson, Cincinnati, OH (US); Stephen Charles Hanak, Middletown, OH (US); Sengottuvelappan Balasubramanian, Cincinnati, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/957,590

(22) Filed: Sep. 20, 2001

(51) Int. Cl. H01R 11/22

(52) U.S. Cl. 439/852

(57) ABSTRACT

An electrical connector, of the pin/socket type, wherein the pin is removable from the socket. Ordinarily, physical movement of the connector causes the contact points between the pin and the socket to redistribute themselves, with deleterious results. The invention constrains the pin to remain in contact with two rail surfaces defined in the socket. As a visual analogy, the pin can be viewed as a large cylindrical tank, supported by railroad tracks parallel with the tank's axis. Cradling the pin in this manner reduces, or eliminates, redistribution of contact points.

### TECHNICAL FIELD

The invention concerns electrical connectors, particularly of the pin-and-socket type, which contain a spring which biases a pin into contact with the socket. The invention exhibits (1) improved reduction in arcing, and (2) less movement of pin/socket contact points during physical movement of the connector.

### BACKGROUND OF THE INVENTION

FIG. 1 illustrates a commercial aircraft 3. Block 6 represents a gas turbine aircraft engine, block 9 represents an electrical alternator powered by the engine 6, elements 12 represent electrical cables connected to the alternator 9, and block 15 represents an electrical connector interconnected within the cable 12.

FIG. 2 represents schematically the cylindrical socket 18, and a leaf spring 21. FIG. 3 shows the components of FIG. 2 in assembled form, and FIG. 4 illustrates a bull-nose, or dome-nose, pin 24, which mates with the socket 18. FIG. 5 is a cross-sectional view of the pin/socket assembly 30, showing pin 24 positioned within the socket 18, with leaf spring 21 biasing the pin 24 into contact with the socket 18.

The connector 15 in FIG. 1 contains one pin/socket assembly 30 for each wire, not individually shown, within the connector 15.

The Inventors have observed what appears to be premature breakage in the leaf spring 21, and other damage to the pin/socket assembly 30.

### SUMMARY OF THE INVENTION

One form of the invention comprises two parallel rail surfaces, perhaps supported on the internal walls of a socket, and a leaf spring parallel with the rails. A pin is also parallel with the rail surfaces. A spring biases the pin into contact with the rail surfaces.

### BRIEF DESCRIPTION OF THE DRAWINGS

FIG. 1 illustrates an aircraft 3 and a schematic representation of an electrical component such as a generator 9 within an engine 6 of the aircraft 3.

FIG. 2 illustrates a socket 18 of an electrical connector, together with a leaf spring 21.

FIG. 3 illustrates the apparatus of FIG. 2 in cutaway view.

FIG. 4 illustrates the apparatus of FIG. 3, together with a pin 24 which inserts into the socket 18.

FIG. 5 is a cross-sectional view of the apparatus of FIG. 4 in assembled form.

FIGS. 6 and 7 illustrate, in exaggerated form, how the pin 24 can move within the socket 18.

FIG. 8 is a cross-sectional side view of the apparatus of FIG. 4 in assembled form.

FIGS. 9 and 10 illustrate, in exaggerated form, how the pin 24 can move within the socket 18.

FIGS. 11 and 12 illustrate one form of the invention.

FIG. 13 illustrates another form of the invention.

FIGS. 14 and 15 illustrate a type of free-body diagram illustrating behavior of the apparatus of FIG. 5.

FIG. 16 illustrates another form of the invention.

FIGS. 17 and 18 illustrate a type of free-body diagram illustrating behavior of the apparatus of FIG. 16

### DETAILED DESCRIPTION OF THE INVENTION

As stated above, the Inventors have identified damage occurring to the pin/socket assembly 30 of FIG. 4. While the precise mechanisms and agencies responsible for the damage may be difficult to identify, several possible sources of damage are the following.

One source is physical movement of the pin 24 within the socket 18, and the results which the movement causes. During operation of the aircraft 3, the connector 15 is subject to movement, due to vibration, and also due to bodily movement of the connector 15 itself, as when the aircraft 3 undergoes a maneuver, or other operations causing relative motion between mating hardware. During a maneuver, such as landing, G-forces arise which move the connector 15.

This movement and vibration can cause the pin 24 to move with respect to the socket 18. For example, FIG. 6 shows the pin 18 displaced leftward, and FIG. 7 shows the pin 18 displaced to the right. In addition, other types of movement are possible. FIG. 8 is a cross-sectional view of the pin 24 within the socket 18, in the ideal configuration. However, movement of the connector 15 can cause the pin 24 to skew, as shown in FIGS. 9 and 10. The ends of the pin 24 become separated from the socket 18, as indicated by gaps 33 and 36.

FIGS. 9 and 10 illustrate a movement of the pin 24 which may be termed pitch, as that term is used in the aircraft industry. A similar type of movement is termed yaw, which can be viewed as pitch in the left-right direction. The pin 24 may experience yaw as well.

The movements just described have a complex effect on the electrical current flowing through the pin/socket assembly 30. When movement occurs, the points of contact between the pin 24 and socket 18 shift. For example, when the pin 24 is positioned as shown in FIG. 10, a point contact occurs at point 39. When the pin 24 is positioned as shown in FIG. 8, surface contact occurs. The point contact of FIG. 10 is a high-resistance flowpath for electrical current, which causes increased current to flow through the spring 21.

Thus, movement of the pin 24 between the two positions results in increased current in the spring 21, followed by a decrease.

This current can heat the spring 21, and re-temper the metal, resulting in loss of clamping force. Further, loss of the clamping force can make the excursions to the positions shown in FIGS. 9 and 10 easier for the pin 24, because the spring 21 is now weaker, thereby promoting additional overheating of the spring 21.

Therefore, a possible cause of breakage of spring 21 is re-tempering because of heating due to sporadic high electrical currents passing through the spring.

In addition, at the microscopic level, the surfaces of the pin 24 and socket 18 in general are not smooth, but can be represented as miniature mountain ranges. At the microscopic level, the surfaces are rough, like sandpaper. When two surfaces roll, or slide, as in shifting from the situation shown in FIG. 6 to that in FIG. 7, the peaks scrape and roll against each other, causing arcing.

The arcing is worsened if the connector 15 is connected directly to the alternator 9, as opposed to being connected to a power supply powered by the alternator which provides DC power. The reason is that, if connected directly to the alternator, the connector 15 is connected to electrical coils. The coils have large inductances. When the arcing occurs, the current through the coils is momentarily interrupted. The interruption causes the well known flyback voltage. The flyback voltage is high, worsening the arcing.

Visible arcing is produced by ionization of the air located in the vicinity of the rough points, on the surfaces of the pin 24 and socket 18. As is well known, a sharp point on a charged conductor is a source of very high electric fields. These electric fields can strip electrons away from air molecules. The visible arcing represents radiation produced by these electrons in falling back into the charged nuclei of the air molecules. That is, the removed electrons return to a lower energy state, and radiate photons in the process. This process is very similar to many processes found in ordinary combustion.

Thus, while each event of visible arcing may be small, and the events may be intermittent, the collective effect of numerous arcing events over time causes heating, pitting, corrosion, and other types of weakening damage to the pin/socket assembly 30.

The invention mitigates the damage just discussed.

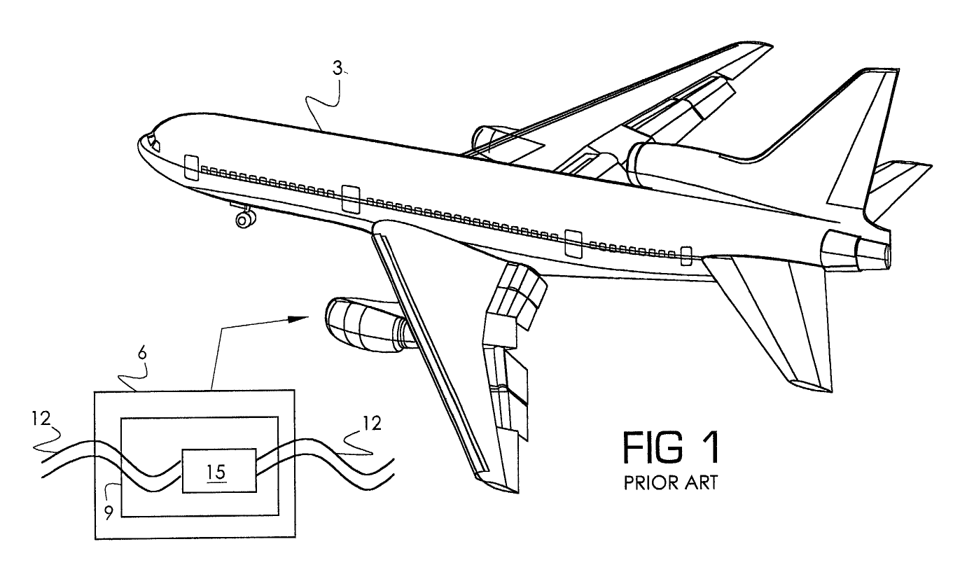

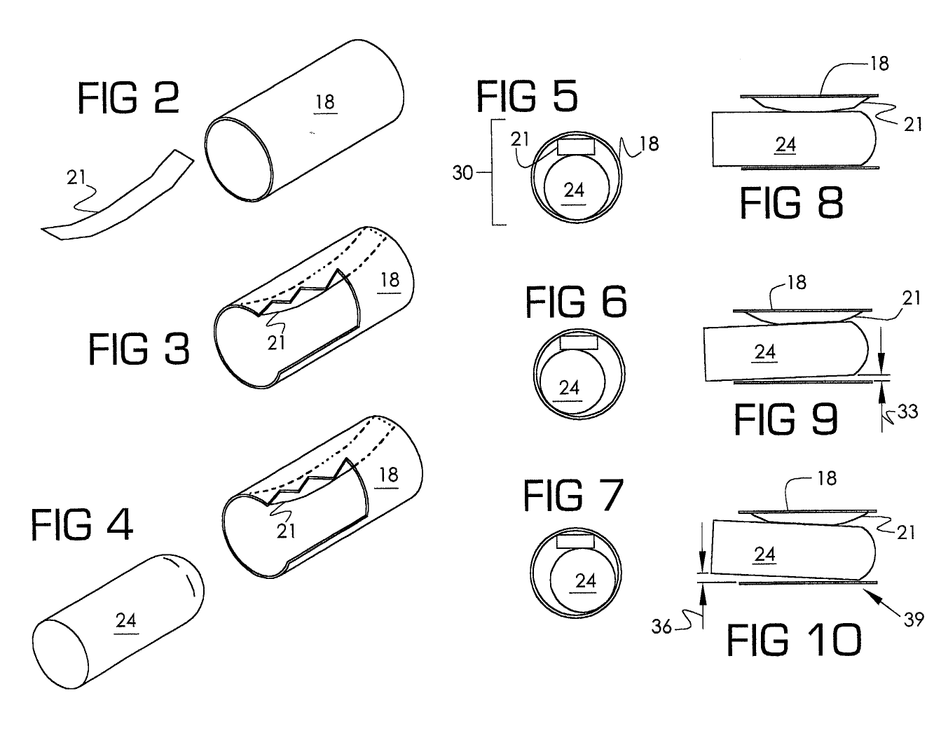

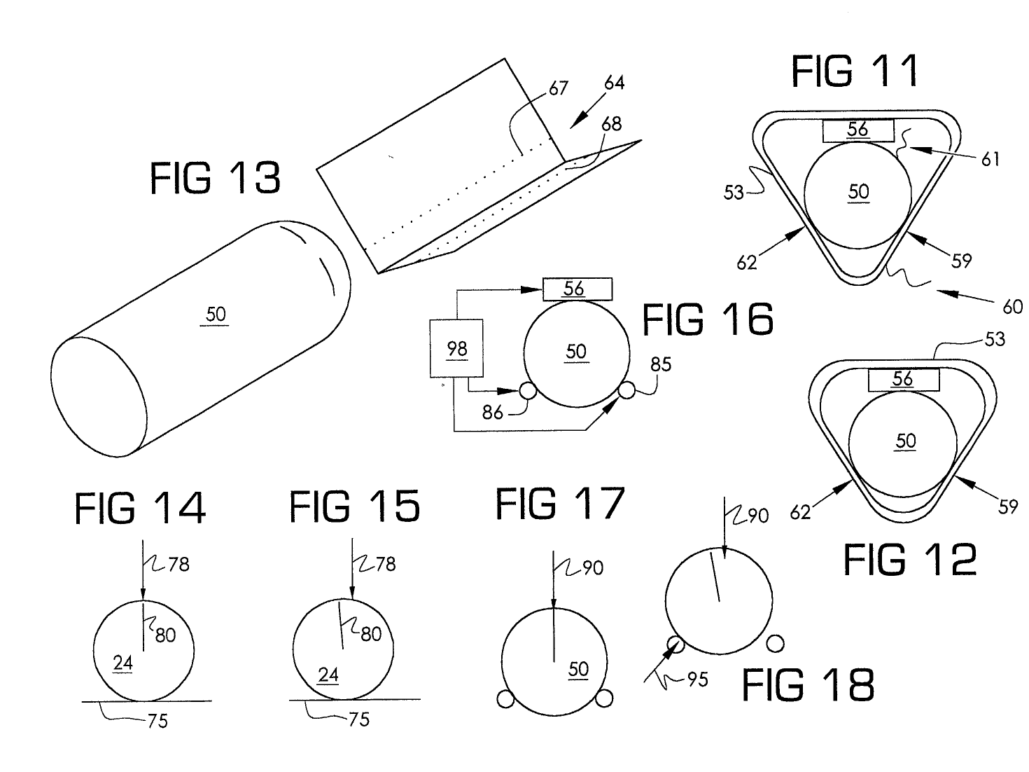

FIGS. 11 and 12 are cross-sectional views of two forms of the invention. Pin 50 is contained within a triangular socket 53. Spring 56 biases the pin 50 into contact at points 59 and 62. Pigtails 60 and 61 represent cables analogous to cables 12 in FIG. 1. Under this arrangement, the rolling described in connection with FIGS. 6 and 7 is significantly restricted.

FIG. 13 is a schematic representation of the apparatus of FIGS. 11 and 12. In effect, a V-surface 64 contacts the pin 50. Contact is made along contact lines 67 and 68, representing tangent points of the pin 50.

Some significant features of the arrangement will be discussed.

The prior art device of FIG. 5 can be represented as shown in FIG. 14, where the socket 18 of FIG. 5 has been replaced by flat surface 75, for ease of explanation. One justification for the flat surface 75 is that the flat surface 75 is still cylindrical, like socket 18, but of a large diameter. Arrow 78 in FIG. 14 represents the force applied by the spring 21 of FIG. 5. Line 80 is a reference line, to show rotation.

When the pin 24 rolls as indicated in FIG. 15, the force 78 is no longer applied to the 12 o'clock position. In fact, as shown in FIG. 15, the force 78 actually promotes further rolling, because the pin 24 reacts to the force 78 along a radius. That radial reaction force has horizontal and vertical components. The horizontal component promotes further rolling.

Of course, the degree to which further rolling is promoted depends on (1) the width of the spring 21, and (2) whether it is constrained to always apply a downward force in FIG. 14.

Therefore, depending on the detailed design of the spring 21, the situation of FIG. 14 can represent an unstable equilibrium.

In contrast, one form of the invention may be viewed as shown in FIG. 16. The contact lines 67 and 68 of FIG. 13 are provided by elongated rails, or rail surfaces, 85 and 86 in FIG. 16, which extend into the paper. Arrow 90 in FIG. 17 represents the force applied by the spring 56 of FIG. 16. If the pin 50 attempts to rotate to the position shown in FIG. 18, arrow 90, shown in its original position, provides a restoring force, tending to restore the pin 50 to the position shown in FIG. 17. The equilibrium is stable.

The invention eliminates, or substantially reduces, surfaces along which the pin 50 can roll. For example, as shown in FIG. 6, the prior art pin 24 can roll up the socket 18. The movement is similar to that of an internal pinion gear inside a ring gear. As in the ring/pinion gears, any rotation of the pin 24 is accompanied by physical displacement of the pin 24, unless slippage occurs.

In contrast, as FIG. 17 indicates, if pin 50 attempts to rotate into the position shown in FIG. 18, rotation only occurs about point 95.

Restated, in FIG. 6, when pin 24 rolls, it climbs the wall of socket 18, unless slippage occurs. From an arcing point of view, both climbing and slippage are deleterious. In contrast, in FIG. 18, rotation of pin 50 is inhibited by spring force 90. If rotation occurs at all, it is about the line represented by point 95. But the contact between pin 50 and line 95 is essentially the same as before. From an arcing perspective, the situation is vastly improved.

FIG. 16 illustrates the elements 56, 85, and 86 in contact with the pin 50. Those elements are supported by a support system 98, which can take many forms, such as that shown in FIGS. 11 and 12. As another example, the support system can take the form of a cage, or exoskeleton. As another example, the socket 53 of FIG. 12 can contain embossments or rods, which perform the function of rails 85 and 86 in FIG. 16. The internal surface of socket 53 can be egg-shaped.

FIG. 16 illustrates electrical contact with the pin 50 at three positions on the circumference of the pin 50. These three positions are circumferentially displaced from each other. These three positions are a cross-sectional representation of three elongated lines, or regions, of contact. Two regions are represented by lines 67 and 68 in FIG. 13, and the other is represented by the length of contact along spring 56. Pin 50 is cradled by the rail surfaces represented by lines 67 and 68, and is biased into contact with those surfaces by spring 56.

FIG. 8 illustrates an analogous contact with a spring 21.

Numerous substitutions and modifications can be undertaken without departing from the true spirit and scope of the invention. What is desired to be secured by Letters Patent is the invention as defined in the following claims.

1. An electrical connector, comprising:
a) a V-shaped receiver;
b) an elongated pin contacting the receiver along two lines of contact; and
c) a spring biasing the pin into the lines of contact.

2. Connector according to claim 1, wherein the elongated pin is cylindrical, with exception of a nose, which may be domed.

3. An electrical connector, comprising:
a) a pin; and
b) means for making electrical contact with the pin within three axially extending regions, which are circumferentially spaced along the pin, and at no other regions on the pin.

4. An electrical connector, comprising:
a) first and second parallel rails;
b) an elongated leaf spring, parallel with the rails;
c) a support for supporting the rails and leaf spring; and
d) an elongated pin in contact with the rails and the leaf spring.

5. Apparatus according to claim 4, wherein the pin has an axis defined therein and the axis is parallel to the rails.

6. A method of making contact between two electrical cables, comprising:
a) maintaining a cylindrical connector pin, having an axis, in contact with a first electrical cable;
b) supporting the connector pin on a pair of elongated rail surfaces which are parallel with the axis;
c) biasing the connector pin into contact with the rail surfaces; and
d) maintaining the rail surfaces in electrical contact with a second electrical cable.

7. Method according to claim 6, and further comprising:
e) receiving electrical current from an alternator in a gas turbine engine; and
f) passing the current through the connector pin and the rail surfaces.

8. Apparatus, comprising:
a) a gas turbine aircraft engine;
b) an electrical alternator driven by the engine, which delivers current on one or more cables;
c) an electrical connector, interconnected within at least one of the cables, comprising:
i) first and second parallel rail surfaces;
ii) an elongated leaf spring, parallel with the rail surfaces;
iii) a support for supporting the rail surfaces and leaf spring; and
iv) an elongated pin in contact with the rails and the leaf spring.

9. Apparatus according to claim 8, wherein the elongated pin has an axis defined therein and the axis is parallel with the rail surfaces.

10. A method, comprising;
a) using an alternator, generating electrical current in a gas turbine engine;
b) passing the current through a cable and to a connector which includes an elongated pin within a socket and a leaf spring pressing the elongated pin against the socket; and
c) within the connector, passing the current through
i) the elongated pin and
ii) an interface between the pin and the socket which includes
A) three discrete lines of contact.

11. Method according to claim 10, wherein two of the discrete lines of contact comprise elongated regions of an inner surface of the socket.

12. Method according to claim 11, wherein a third of the discrete lines of contact run along a leaf spring.

13. Method, comprising:
a) maintaining an electrical socket;
b) cradling a connector pin within the socket on a pair of rail surfaces parallel with the connector pin; and
c) using a spring to bias the connector pin against the rail surfaces.

14. Apparatus, comprising:
a) an electrical socket connector;
b) an electrical pin connector within the socket connector; and
c) means for preventing rolling motion in the pin from resulting in climbing of the pin within the socket.
